(19) United States
(12) Patent Application Publication
(10) Pub. No.: US 2024/0153262 A1
(43) Pub. Date: May 9, 2024

(54) DEVICE FOR MANAGING A VISUAL SALIENCY MODEL AND CONTROL METHOD THEREOF

(71) Applicant: LG ELECTRONICS INC., Seoul (KR)

(72) Inventors: SEN JIA, Toronto (CA); HOMA FASHANDI, Toronto (CA); NEIL BRUCE, Guelph (CA)

(73) Assignee: LG ELECTRONICS INC., Seoul (KR)

(21) Appl. No.: 18/386,983

(22) Filed: Nov. 3, 2023

Related U.S. Application Data
(60) Provisional application No. 63/422,416, filed on Nov. 3, 2022.

(51) Int. Cl. G06V 10/98; G06V 10/32; G06V 10/46

(52) U.S. Cl. CPC G06V 10/98; G06V 10/32; G06V 10/46

(57) ABSTRACT

A method for controlling a device to manage a visual saliency model can include receiving, via a processor in the device, a center bias map and a saliency density ground-truth map for an image; normalizing values of the saliency density ground-truth map to generate a normalized density ground-truth map; and comparing values of the normalized density ground-truth map to a predefined threshold value to generate an enhanced ground-truth map. The method can further include subtracting the enhanced ground-truth map from the center bias map to generate a negative candidates map; normalizing values of the negative candidates map to generate a normalized candidates map; and performing a sampling process on the normalized candidates map to generate a negative point map. Also, the method includes applying a filter function to the negative point map to generate a negative density map.

### CROSS-REFERENCE TO RELATED APPLICATIONS

This non-provisional application claims priority under 35 U.S.C. § 119(e) to U.S. Provisional Application No. 63/422,416, filed on Nov. 3, 2022, the entirety of which is hereby expressly incorporated by reference into the present application.

### BACKGROUND

### Field

The present disclosure relates to a device and method of evaluating and managing visual saliency models while accounting for center bias in the field of artificial intelligence (AI). Particularly, the method can select a visual saliency model from among a plurality of visual saliency models and apply the selected visual saliency model to direct or focus one or more functions or actions to yield better results in a more efficient manner in the AI field.

### Discussion of the Related Art

Visual saliency models are used to predict where humans will look in a scene or which areas of an image will be focused on. This is done by simulating the early stages of human visual processing, which are responsible for detecting and highlighting important or interesting features in the environment. These models have many applications in cognitive science and engineering, such as saliency-guided object detection and avoidance (e.g., self-driving vehicles or robots), image quality assessment, advertising and video and image compression.

However, visual saliency models may be biased towards the center of an image, which can be referred to as a center bias problem. The center bias problem in saliency refers to the tendency of saliency models to predict higher saliency or greater importance for objects located in the center of an image, even if more interesting objects are located elsewhere (e.g., at the periphery).

For example, a common problem with visual saliency models is that they are often trained on datasets in which the collected fixations tend to be near the center (e.g., photographers often place an object of interest at the center of their pictures due to habit). Also, humans tend to look at the center of an image more than other areas of the image. This means that the visual saliency models learn to associate saliency with the center region of the image.

When these visual saliency models are applied to new images, they may overpredict saliency for objects in the center of the image or scene, even if those objects are not actually important or noticeable. This center bias can interfere with the evaluation of visual saliency models, e.g., a trivial or simple visual saliency model (e.g., in the form of a centered Gaussian distribution) that blindly predicts the salient region to be around the center can seemingly outperform other saliency models, even if those other saliency models are more adaptive and more sophisticated.

A number of methods have been proposed to address the center bias problem in visual saliency model evaluation. However, these methods have various drawbacks. For example, some methods over-penalize the center region and may leave out true fixations, while some methods are computationally intensive and have O(n) linear time complexity or worse, or they may be peripherally biased.

### SUMMARY OF THE DISCLOSURE

The present disclosure has been made in view of the above problems and it is an object of the present disclosure to provide a device and method that can better evaluate visual saliency models while accounting for center bias.

It is another object of the present disclosure to provide a method and device that can select a best visual saliency model from among a plurality of visual saliency models and apply the selected visual saliency model to direct or focus one or more functions or actions to yield better results in a more efficient manner.

It is another object of the present disclosure to provide a method and device that apply a Center-Negative technique that can deal with the center bias more efficiently and effectively when evaluating visual saliency models.

Another object of the present disclosure to provide a method that includes receiving, via a processor in a device, a center bias map and a saliency density ground-truth map for an image, normalizing, via the processor, values of the saliency density ground-truth map to be in a range of 0 to 1 to generate a normalized density ground-truth map, comparing, via the processor, values of the normalized density ground-truth map to a predefined threshold value to generate an enhanced ground-truth map, subtracting, via the processor, the enhanced ground-truth map from the center bias map to generate a negative candidates map, normalizing, via the processor, values of the negative candidates map to be in a range of 0 to 1 to generate a normalized candidates map, performing, via the processor, a sampling process on the normalized candidates map to generate a negative point map, and applying, via the processor, a filter function to the negative point map to generate a negative density map.

It is another object of the present disclosure to provide a method that includes generating the enhanced ground-truth map includes converting some values of the saliency density ground-truth map that are less than the predefined threshold to zero and converting other values of the saliency density ground-truth map that are greater than the predefined threshold to one.

It is another object of the present disclosure to provide a method that includes receiving a first visual saliency prediction map corresponding to a first visual saliency prediction model, and comparing the first visual saliency prediction map to the negative density map to generate a first correlation value.

It is another object of the present disclosure to provide a method that includes comparing the visual saliency prediction map to the saliency density ground-truth map to generate a second correlation value, and generating an evaluation metric for the first visual saliency prediction model based on the first correlation value and the second correlation value.

It is an object of the present disclosure to provide a method that includes subtracting first correlation value from the second correlation value to generate a score for the first visual saliency prediction model.

It is an object of the present disclosure to provide a method that includes comparing evaluation metrics of a plurality of visual saliency prediction models with each other, selecting one of the plurality of visual saliency prediction models based on a condition, and executing a function or action based on a visual saliency prediction map output by the one of the plurality of visual saliency prediction models.

Another object of the present disclosure to provide a method that includes receiving a center bias map and a saliency density ground-truth map for an image, generating a negative candidates map based on a difference between the center bias map and the saliency density ground-truth map, and generating a negative density map based on the negative candidates map.

Yet another object of the present disclosure is to provide a device including a memory configured to store one or more saliency density ground-truth maps for one or more images, the one or more saliency density ground-truth maps corresponding to one or more visual saliency prediction models, and a controller configured to receive a center bias map and a saliency density ground-truth map for an image, normalize values of the saliency density ground-truth map to be in a range of 0 to 1 to generate a normalized density ground-truth map, compare values of the normalized density ground-truth map to a predefined threshold value to generate an enhanced ground-truth map, subtract the enhanced ground-truth map from the center bias map to generate a negative candidates map, normalize values of the negative candidates map to be in a range of 0 to 1 to generate a normalized candidates map, perform a sampling process on the normalized candidates map to generate a negative point map, and apply a filter function to the negative point map to generate a negative density map.

In addition to the objects of the present disclosure as mentioned above, additional objects and features of the present disclosure will be clearly understood by those skilled in the art from the following description of the present disclosure.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, which are briefly described below.

FIG. 1 illustrates an AI device according to an embodiment of the present disclosure.

FIG. 2 illustrates an AI server according to an embodiment of the present disclosure.

FIG. 3 illustrates an AI device according to an embodiment of the present disclosure.

FIG. 4 illustrates a center bias map including a 2D (two-dimensional) Gaussian distribution according to an embodiment of the present disclosure.

FIG. 5 illustrates a flow chart of a method according to an embodiment of the present disclosure.

FIG. 6 illustrates a flow chart of a method according to another embodiment of the present disclosure.

FIG. 7 illustrates a method applied with saliency metrics for evaluation according to an embodiment of the present disclosure.

### DETAILED DESCRIPTION OF THE EMBODIMENTS

Reference will now be made in detail to the embodiments of the present disclosure, examples of which are illustrated in the accompanying drawings.

Wherever possible, the same reference numbers will be used throughout the drawings to refer to the same or like parts.

Advantages and features of the present disclosure, and implementation methods thereof will be clarified through following embodiments described with reference to the accompanying drawings.

The present disclosure can, however, be embodied in different forms and should not be construed as limited to the embodiments set forth herein.

Rather, these embodiments are provided so that this disclosure will be thorough and complete, and will fully convey the scope of the present disclosure to those skilled in the art.

A shape, a size, a ratio, an angle, and a number disclosed in the drawings for describing embodiments of the present disclosure are merely an example, and thus, the present disclosure is not limited to the illustrated details.

Like reference numerals refer to like elements throughout. In the following description, when the detailed description of the relevant known function or configuration is determined to unnecessarily obscure the important point of the present disclosure, the detailed description will be omitted.

In a situation where “comprise,” “have,” and “include” described in the present specification are used, another part can be added unless “only” is used. The terms of a singular form can include plural forms unless referred to the contrary.

In construing an element, the element is construed as including an error range although there is no explicit description. In describing a position relationship, for example, when a position relation between two parts is described as “on,” “over,” “under,” and “next,” one or more other parts can be disposed between the two parts unless ‘just’ or ‘direct’ is used.

In describing a temporal relationship, for example, when the temporal order is described as “after,” “subsequent,” “next,” and “before,” a situation which is not continuous can be included, unless “just” or “direct” is used.

It will be understood that, although the terms “first,” “second,” etc. can be used herein to describe various elements, these elements should not be limited by these terms.

These terms are only used to distinguish one element from another. For example, a first element could be termed a second element, and, similarly, a second element could be termed a first element, without departing from the scope of the present disclosure.

Further, “X-axis direction,” “Y-axis direction” and “Z-axis direction” should not be construed by a geometric relation only of a mutual vertical relation and can have broader directionality within the range that elements of the present disclosure can act functionally.

The term “at least one” should be understood as including any and all combinations of one or more of the associated listed items.

For example, the meaning of “at least one of a first item, a second item and a third item” denotes the combination of all items proposed from two or more of the first item, the second item and the third item as well as the first item, the second item or the third item.

Features of various embodiments of the present disclosure can be partially or overall coupled to or combined with each other and can be variously inter-operated with each other and driven technically as those skilled in the art can sufficiently understand. The embodiments of the present disclosure can be carried out independently from each other or can be carried out together in co-dependent relationship.

Hereinafter, the preferred embodiments of the present disclosure will be described in detail with reference to the accompanying drawings. All the components of each device or apparatus according to all embodiments of the present disclosure are operatively coupled and configured.

Artificial intelligence (AI) refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and can mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network can include an input layer, an output layer, and optionally one or more hidden layers. Each layer includes one or more neurons, and the artificial neural network can include a synapse that links neurons to neurons. In the artificial neural network, each neuron can output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network can be to determine the model parameters that minimize a loss function. The loss function can be used as an index to determine optimal model parameters in the learning process of the artificial neural network.

Machine learning can be classified into supervised learning, unsupervised learning, and reinforcement learning according to a learning method.

The supervised learning can refer to a method of learning an artificial neural network in a state in which a label for learning data is given, and the label can mean the correct answer (or result value) that the artificial neural network must infer when the learning data is input to the artificial neural network. The unsupervised learning can refer to a method of learning an artificial neural network in a state in which a label for learning data is not given. The reinforcement learning can refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

Self-driving refers to a technique of driving for oneself, and a self-driving vehicle refers to a vehicle that travels without an operation of a user or with a minimum operation of a user.

For example, the self-driving can include a technology for maintaining a lane while driving, a technology for automatically adjusting a speed, such as adaptive cruise control, a technique for automatically traveling along a predetermined route, and a technology for automatically setting and traveling a route when a destination is set.

The vehicle can include a vehicle having only an internal combustion engine, a hybrid vehicle having an internal combustion engine and an electric motor together, and an electric vehicle having only an electric motor, and can include not only an automobile but also a train, a motorcycle, and the like.

At this time, the self-driving vehicle can be regarded as a robot having a self-driving function.

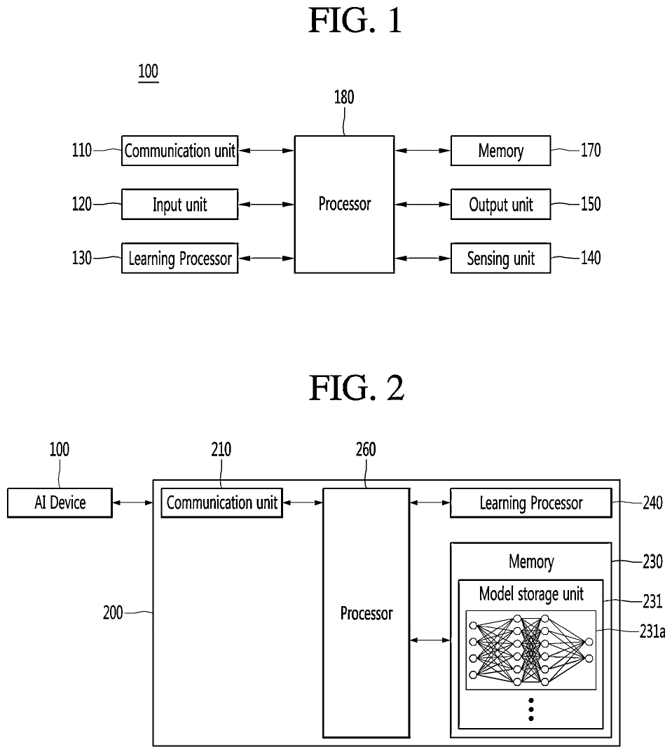

FIG. 1 illustrates an artificial intelligence (AI) device 100 according to one embodiment.

The AI device 100 can be implemented by a stationary device or a mobile device, such as a television (TV), a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like. However, other variations are possible.

Referring to FIG. 1, the AI device 100 can include a communication unit 110 (e.g., transceiver), an input unit 120 (e.g., touchscreen, keyboard, mouse, microphone, etc.), a learning processor 130, a sensing unit 140 (e.g., one or more sensors or one or more cameras), an output unit 150 (e.g., a display or speaker), a memory 170, and a processor 180 (e.g., a controller).

The communication unit 110 (e.g., communication interface or transceiver) can transmit and receive data to and from external devices such as other AI devices 100a to 100e and the AI server 200 by using wire/wireless communication technology. For example, the communication unit 110 can transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), BLUETOOTH, RFID (Radio Frequency Identification), Infrared Data Association (IrDA), ZIGBEE, NFC (Near Field Communication), and the like.

The input unit 120 can acquire various kinds of data.

At this time, the input unit 120 can include a camera for inputting a video signal, a microphone for receiving an audio signal, and a user input unit for receiving information from a user. The camera or the microphone can be treated as a sensor, and the signal acquired from the camera or the microphone can be referred to as sensing data or sensor information.

The input unit 120 can acquire a learning data for model learning and an input data to be used when an output is acquired by using learning model. The input unit 120 can acquire raw input data. In this situation, the processor 180 or the learning processor 130 can extract an input feature by preprocessing the input data.

The learning processor 130 can learn a model composed of an artificial neural network by using learning data. The learned artificial neural network can be referred to as a learning model. The learning model can be used to an infer result value for new input data rather than learning data, and the inferred value can be used as a basis for determination to perform a certain operation.

At this time, the learning processor 130 can perform AI processing together with the learning processor 240 of the AI server 200.

At this time, the learning processor 130 can include a memory integrated or implemented in the AI device 100. Alternatively, the learning processor 130 can be implemented by using the memory 170, an external memory directly connected to the AI device 100, or a memory held in an external device.

The sensing unit 140 can acquire at least one of internal information about the AI device 100, ambient environment information about the AI device 100, and user information by using various sensors.

Examples of the sensors included in the sensing unit 140 can include a proximity sensor, an illuminance sensor, an acceleration sensor, a magnetic sensor, a gyro sensor, an inertial sensor, an RGB sensor, an IR (infrared) sensor, a fingerprint recognition sensor, an ultrasonic sensor, an optical sensor, a camera, a microphone, a lidar, and a radar.

The output unit 150 can generate an output related to a visual sense, an auditory sense, or a haptic sense.

At this time, the output unit 150 can include a display unit for outputting time information, a speaker for outputting auditory information, and a haptic module for outputting haptic information.

The memory 170 can store data that supports various functions of the AI device 100. For example, the memory 170 can store input data acquired by the input unit 120, learning data, a learning model, a learning history, and the like.

The processor 180 can determine at least one executable operation of the AI device 100 based on information determined or generated by using a data analysis algorithm or a machine learning algorithm. The processor 180 can control the components of the AI device 100 to execute the determined operation. For example, the processor 180 can execute a visual saliency prediction model. The visual saliency prediction model can predict which regions of an image or scene a person will focus. For example, the visual saliency prediction model can generate a type of heat map indicating where viewers are likely to look or eye tracking patterns.

To this end, the processor 180 can request, search, receive, or utilize data of the learning processor 130 or the memory 170. The processor 180 can control the components of the AI device 100 to execute the predicted operation or the operation determined to be desirable among the at least one executable operation.

When the connection of an external device is required to perform the determined operation, the processor 180 can generate a control signal for controlling the external device and can transmit the generated control signal to the external device.

The processor 180 can acquire intention information for the user input and can determine the user's requirements based on the acquired intention information.

The processor 180 can acquire the intention information corresponding to the user input by using at least one of a speech to text (STT) engine for converting speech input into a text string or a natural language processing (NLP) engine for acquiring intention information of a natural language.

At least one of the STT engine or the NLP engine can be configured as an artificial neural network, at least part of which is learned according to the machine learning algorithm. At least one of the STT engine or the NLP engine can be learned by the learning processor 130, can be learned by the learning processor 240 of the AI server 200 (see FIG. 2), or can be learned by their distributed processing.

The processor 180 can collect history information including the operation contents of the AI apparatus 100 or the user's feedback on the operation and can store the collected history information in the memory 170 or the learning processor 130 or transmit the collected history information to the external device such as the AI server 200. The collected history information can be used to update the learning model.

The processor 180 can control at least part of the components of AI device 100 to drive an application program stored in memory 170. Furthermore, the processor 180 can operate two or more of the components included in the AI device 100 in combination to drive the application program.

FIG. 2 illustrates an AI server connected to a robot according to one embodiment.

Referring to FIG. 2, the AI server 200 can refer to a device that learns an artificial neural network by using a machine learning algorithm or uses a learned artificial neural network. The AI server 200 can include a plurality of servers to perform distributed processing, or can be defined as a 5G network, 6G network or other communications network. At this time, the AI server 200 can be included as a partial configuration of the AI device 100, and can perform at least part of the AI processing together.

The AI server 200 can include a communication unit 210, a memory 230, a learning processor 240, a processor 260, and the like.

The communication unit 210 can transmit and receive data to and from an external device such as the AI device 100.

The memory 230 can include a model storage unit 231. The model storage unit 231 can store a learning or learned model (or an artificial neural network 231a) through the learning processor 240.

The learning processor 240 can learn the artificial neural network 231a by using the learning data. The learning model can be used in a state of being mounted on the AI server 200 of the artificial neural network, or can be used in a state of being mounted on an external device such as the AI device 100.

The learning model can be implemented in hardware, software, or a combination of hardware and software. If all or part of the learning models are implemented in software, one or more instructions that constitute the learning model can be stored in memory 230.

The processor 260 can infer the result value for new input data by using the learning model and can generate a response or a control command based on the inferred result value.

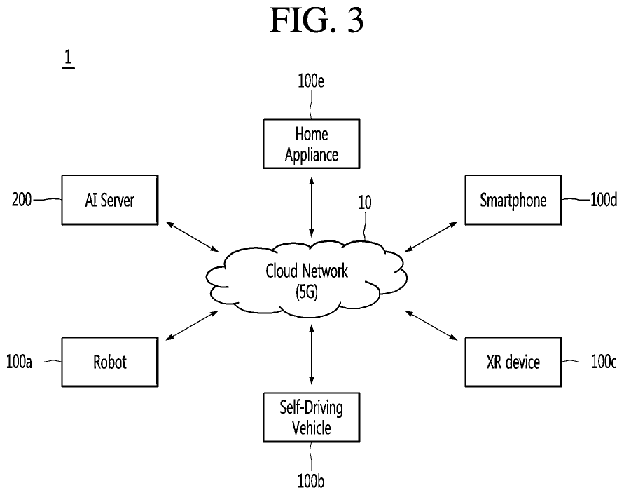

FIG. 3 illustrates an AI system 1 including a robot according to one embodiment.

Referring to FIG. 3, in the AI system 1, at least one of an AI server 200, a robot 100a, a self-driving vehicle 100b, an XR (extended reality) device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, can be referred to as AI devices 100a to 100e. The AI server 200 of FIG. 3 can have the configuration of the AI server 200 of FIG. 2.

The cloud network 10 can refer to a network that forms part of a cloud computing infrastructure or exists in a cloud computing infrastructure. The cloud network 10 can be configured by using a 3G network, a 4G or LTE network, a 5G network, a 6G network, or other network.

For instance, the devices 100a to 100e and 200 configuring the AI system 1 can be connected to each other through the cloud network 10. In particular, each of the devices 100a to 100e and 200 can communicate with each other through a base station, but can directly communicate with each other without using a base station.

The AI server 200 can include a server that performs AI processing and a server that performs operations on big data.

The AI server 200 can be connected to at least one of the AI devices constituting the AI system 1, that is, the robot 100a, the self-driving vehicle 100b, the XR device 100c, the smartphone 100d, or the home appliance 100e through the cloud network 10, and can assist at least part of AI processing of the connected AI devices 100a to 100e.

At this time, the AI server 200 can learn the artificial neural network according to the machine learning algorithm instead of the AI devices 100a to 100e, and can directly store the learning model or transmit the learning model to the AI devices 100a to 100e.

At this time, the AI server 200 can receive input data from the AI devices 100a to 100e, can infer the result value for the received input data by using the learning model, can generate a response or a control command based on the inferred result value, and can transmit the response or the control command to the AI devices 100a to 100e. Each AI device 100a to 100e can have the configuration of the AI device 100 of FIGS. 1 and 2 or other suitable configurations.

Alternatively, the AI devices 100a to 100e can infer the result value for the input data by directly using the learning model, and can generate the response or the control command based on the inference result.

Hereinafter, various embodiments of the AI devices 100a to 100e to which the above-described technology is applied will be described. The AI devices 100a to 100e illustrated in FIG. 3 can be regarded as a specific embodiment of the AI device 100 illustrated in FIG. 1.

The robot 100a, to which the AI technology is applied, can be implemented as a guide robot, a carrying robot, a cleaning robot, a wearable robot, an entertainment robot, a pet robot, an unmanned flying robot, or the like.

The robot 100a can include a robot control module for controlling the operation, and the robot control module can refer to a software module or a chip implementing the software module by hardware.

The robot 100a can acquire state information about the robot 100a by using sensor information acquired from various kinds of sensors, can detect (recognize) surrounding environment and objects, can generate map data, can determine the route and the travel plan, can determine the response to user interaction, or can determine the operation.

The robot 100a can use the sensor information acquired from at least one sensor among the lidar, the radar, and the camera to determine the travel route and the travel plan.

The robot 100a can perform the above-described operations by using the learning model composed of at least one artificial neural network. For example, the robot 100a can recognize the surrounding environment and the objects by using the learning model, and can determine the operation by using the recognized surrounding information or object information. The learning model can be learned directly from the robot 100a or can be learned from an external device such as the AI server 200.

At this time, the robot 100a can perform the operation by generating the result by directly using the learning model, but the sensor information can be transmitted to the external device such as the AI server 200 and the generated result can be received to perform the operation.

The robot 100a can use at least one of the map data, the object information detected from the sensor information, or the object information acquired from the external apparatus to determine the travel route and the travel plan, and can control the driving unit such that the robot 100a travels along the determined travel route and travel plan.

The map data can include object identification information about various objects arranged in the space in which the robot 100a moves. For example, the map data can include object identification information about fixed objects such as walls and doors and movable objects such as pollen and desks. The object identification information can include a name, a type, a distance, and a position.

In addition, the robot 100a can perform the operation or travel by controlling the driving unit based on the control/interaction of the user. At this time, the robot 100a can acquire the intention information of the interaction due to the user's operation or speech utterance, and can determine the response based on the acquired intention information, and can perform the operation.

The robot 100a, to which the AI technology and the self-driving technology are applied, can be implemented as a guide robot, a carrying robot, a cleaning robot (e.g., an automated vacuum cleaner), a wearable robot, an entertainment robot, a pet robot, an unmanned flying robot (e.g., a drone or quadcopter), or the like.

The robot 100a, to which the AI technology and the self-driving technology are applied, can refer to the robot itself having the self-driving function or the robot 100a interacting with the self-driving vehicle 100b.

The robot 100a having the self-driving function can collectively refer to a device that moves for itself along the given movement line without the user's control or moves for itself by determining the movement line by itself.

The robot 100a and the self-driving vehicle 100b having the self-driving function can use a common sensing method to determine at least one of the travel route or the travel plan. For example, the robot 100a and the self-driving vehicle 100b having the self-driving function can determine at least one of the travel route or the travel plan by using the information sensed through the lidar, the radar, and the camera.

The robot 100a that interacts with the self-driving vehicle 100b exists separately from the self-driving vehicle 100b and can perform operations interworking with the self-driving function of the self-driving vehicle 100b or interworking with the user who rides on the self-driving vehicle 100b.

At this time, the robot 100a interacting with the self-driving vehicle 100b can control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b can monitor the user boarding the self-driving vehicle 100b, or can control the function of the self-driving vehicle 100b through the interaction with the user. For example, when it is determined that the driver is in a drowsy state, the robot 100a can activate the self-driving function of the self-driving vehicle 100b or assist the control of the driving unit of the self-driving vehicle 100b. The function of the self-driving vehicle 100b controlled by the robot 100a can include not only the self-driving function but also the function provided by the navigation system or the audio system provided in the self-driving vehicle 100b.

Alternatively, the robot 100a that interacts with the self-driving vehicle 100b can provide information or assist the function to the self-driving vehicle 100b outside the self-driving vehicle 100b. For example, the robot 100a can provide traffic information including signal information and the like, such as a smart signal, to the self-driving vehicle 100b, and automatically connect an electric charger to a charging port by interacting with the self-driving vehicle 100b like an automatic electric charger of an electric vehicle.

According to an embodiment, the AI device 100 can execute a function or action based on a visual saliency model. Further, the AI device 100 can have access to a plurality of visual saliency models and can select one of the plurality of visual saliency models to generate a predicted heat map for an image indicating where a human viewer is likely to focus on. This type of heat map can be used by the AI device 100 to focus or direct processing resources and prioritize tasks. For example, the predicted heat map generated by the AI device 100 using the selected visual saliency model can guide which parts of an image or scene can be generated with high resolution and which areas can be afforded to be or get away with being generated with lower resolution. Also, the predicted heat map generated by the AI device 100 can be used to decide which objects to focus on first when performing object detection, e.g., when performing a self-driving function.

However, it is desirable for AI device 100 to be able to accurately pick the best visual saliency model from among the plurality of visual saliency models to use to generate the predicted heat map and based on different context situations. Further, it desirable for the AI device 100 to have a way to be able to determine or evaluate the best visual saliency model to use that is not skewed or unduly influenced by center bias. Thus, according to one or more embodiments of the present disclosure, a Center-Negative solution evaluation and management method is provided that can allow the best visual saliency model to be selected from among a plurality of visual saliency models that can also account for center bias and help the AI device 100 better perform tasks using better visual processing and predicted eye fixations.

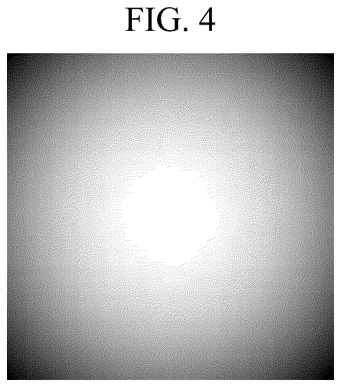

FIG. 4 illustrates a center bias map including a 2D Gaussian distribution that is placed at the center of a canvas or image according to an embodiment of the present disclosure. The center bias map can be using in a Center-Negative solution evaluation and management method, according to an embodiment of the present disclosure.

Referring to FIG. 4, for example, a centered Gaussian distribution, such as the MIT saliency benchmark can be used as a baseline. The values of the center bias map can be normalized into a range including zero to one (e.g., 0.0, 0.25, 0.5, 0.75, 1.0, etc.), but embodiments are not limited thereto. For example, FIG. 4 shows a normal distribution in two dimensions in which larger values are clustered about the center (e.g., represented by whiter/brighter areas) and lower values are located around the periphery (e.g., represented by black or darker areas). This distribution corresponds to or represents a center bias fixation issue that plagues various types of visual saliency model.

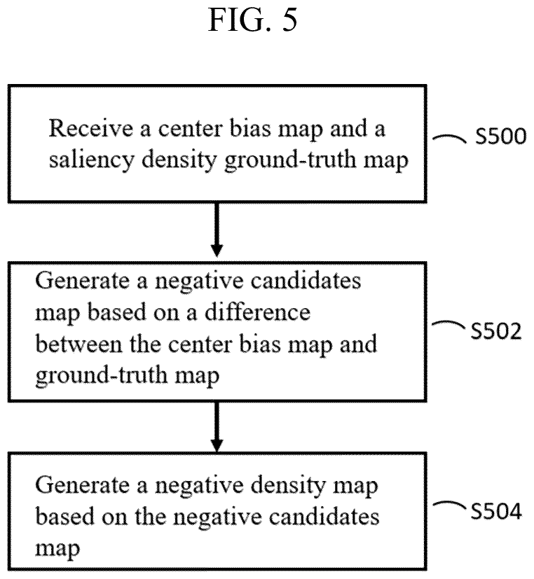

FIG. 5 illustrates a method of generating a negative density map for a given image according to an embodiment of the present disclosure.

Referring to FIG. 5, for example, according to an embodiment, a device can receive a center bias map and a saliency density ground-truth map for an image (S500), generate a negative candidates map based on a difference between the center bias map and the saliency density ground-truth map (S502), and generate a negative density map based on the negative candidates map (S504).

Further in this example, the device can normalize values of the saliency density ground-truth map to be in a range of 0 to 1 to generate a normalized density ground-truth map, compare values of the normalized density ground-truth map to a predefined threshold value to generate an enhanced ground-truth map, normalize values of the negative candidates map to be in a range of 0 to 1 to generate a normalized candidates map, and perform a sampling process on the normalized candidates map to generate a negative point map.

Also, the negative candidates map can be generated based on the enhanced ground-truth map, and the negative density map is generated based on the negative point map, but embodiments are not limited thereto.

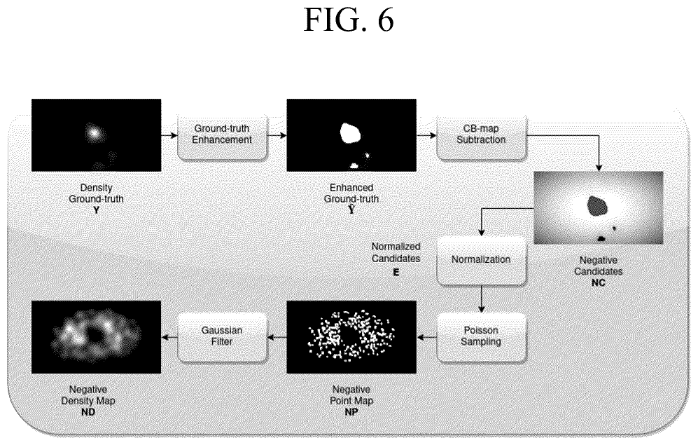

FIG. 6 illustrates a method of generating a negative point map for a given image according to an embodiment of the present disclosure.

Referring to FIG. 6, when evaluating saliency, a ground-truth saliency map (Y) can be used. The ground-truth saliency map (Y) can be a saliency map that is provided along with a given dataset. The ground-truth saliency map (Y) can be created by an eye-tracker to capture where humans may gaze at given an image or video. Also, a visual saliency model can be trained on the ground-truth saliency map (Y) to mimic human viewing or gazing behavior. The ground-truth saliency map (Y) can be referred to herein as a density ground-truth map (Y).

Further, the ground-truth saliency map (Y) can be enhanced by thresholding to generate an enhanced ground-truth map (\tilde{Y}). For example, the thresholding process can include normalizing the values of the ground-truth map based on a predefined threshold into a range of zero and one (e.g., [0,1]). According to an embodiment, a purpose of the enhancement can be to draw or generate only those negative points that are sufficiently far away from the positive points. For example, the predefined threshold can be set or adjusted to control to what extend the center bias (CB) map is penalized when the positives are also near the center.

In this situation, the values that are greater than a predefined threshold (e.g., 0.7 or 0.8, etc.) can be set to one, as shown in FIG. 6 (e.g., represented by white part). Then the center bias map (e.g., FIG. 4) can be resized to the same shape as the enhanced ground-truth map (Y).

Further, the center bias (CB) map can be subtracted from the enhanced ground-truth (\tilde{Y}) to generate a negative candidates map NC (e.g., CB−\tilde{Y}=NC). For example, values below zero in the negative candidates map NC indicate the ground-truth density is higher than the center bias (CB) map and those locations should not be sampled as negatives. The negative candidates map NC can be used to penalize visual saliency models that fixate on these emphasized candidates.

For example, the negative candidates can represent bad candidates or center biased candidates, while still excusing or allowing for proper fixation on areas that correspond to the ground-truth saliency map (Y) or the enhanced ground-truth map (\tilde{Y}). In other words, too much fixation on the center region should be penalized to some degree, but should allow for proper fixation that corresponding to real center points (e.g., portions corresponding to the heat map measured according to real human viewers).

Also, the values of the negative candidates map NC can be normalized into the range including zero and one, which is denoted as normalized candidates map E in FIG. 6.

The normalized candidates map E can then be used as inclusion probabilities for Poisson sampling to draw a set of negative points, as shown the negative point map NP in FIG. 6. For example, each location (m, n) in the normalized candidates map E is a candidate for the negative point map NP to be selected with an inclusion probability, location (m, n) in the negative point map NP is set to one if it is selected and otherwise it is set to zero, e.g., Pr(NP(m, n)=1)=If(m,n)=E(m, n).

For example, by sampling from the negative candidates map NC, for each location in the negative candidates map NC, its value can be considered inclusion probability. For example, using Poisson sampling as an example, given a matrix filled with zeros with the same size as the negative candidates map NC, for each location in the map, if a random number is lower than the value in the candidates map, the value in the same location in the matrix can be set to one to generate the negative point map NP.

In addition, the negative point map NP can be a binary negative point map. For example, the process can start by initializing an all-zero canvas whose size is the same as the ground-truth saliency map (Y). For each pixel in the newly created canvas, the intensity value can be set to one if a random number is greater than the value in the subtracted map at the same location.

Then the number of the drawn negative points can be clipped to the same number of the positive fixations by random selection.

Further, a 2D Gaussian filter can be applied on the negative point map NP to create a negative density map ND in FIG. 6. Also, the 2D Gaussian filter can have a specified standard deviation. For example, the negative point map NP can be blurred by applying a Gaussian function or a blurring function to generate a continuous density map, which can be referred to as the negative density map ND. This process can be interpreted as the location is more likely to be sampled as a negative if its value has high correlation with the center bias (CB) map and low correlation with the ground-truth saliency map (Y), which can penalize the center bias (CB) map without hurting the proper fixations.

In addition, an output of a specific visual saliency model can be compared to the negative density map ND, and a high correlation between the specific visual saliency model and the negative density map ND can indicate that the specific visual saliency model is a poor model that has an undue center bias. Conversely, a low correlation between the specific visual saliency model and the negative density map ND can indicate that the specific visual saliency model is a good model that is not unduly infected with center bias.

In this way, a method according to an embodiment can apply a Center-Negative technique that can deal with the center bias more efficiently and effectively when evaluating visual saliency models. Also, the evaluation method of the present disclosure only takes O(1) constant time complexity, which is much faster than O(n) linear time complexity. Thus, the evaluation method according to the present disclosure can conserve computing resources and reduce energy consumption, which is advantageous.

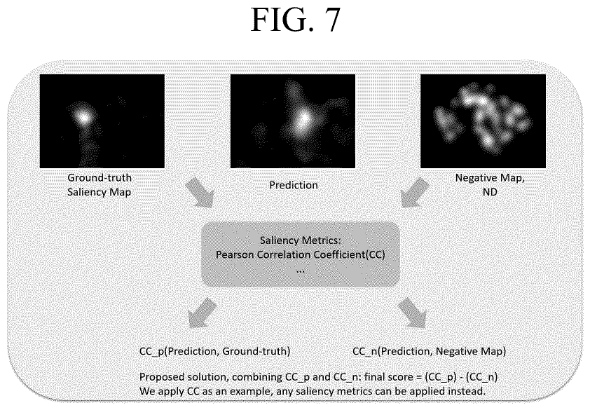

FIG. 7 illustrates a method applied with saliency metrics for evaluation according to an embodiment of the present disclosure.

Referring to FIG. 7, for example, a Pearson Correlation Coefficient (CC) can be used as a saliency metric that measures the linear correlation between the ground-truth saliency map and the predicted one predicted by a specific visual saliency model, and CC values can be in a range of [−1, 1], but embodiments are not limited thereto.

Further in this example, a high absolute value can represent a higher linear correlation between the two maps, and a low value close to zero can represent little or no such correlation. Accordingly, to evaluate a specific visual saliency model, two such correlations can be measured, e.g., 1) between the predicted map (“Prediction” in FIG. 7) from the specific visual saliency model and the ground truth map (“Ground-truth Saliency Map” in FIG. 7) to generate a correlation coefficient positive value (e.g., CC_p) and 2) between the negative density map ND (“Negative Map, ND” in FIG. 7) and the ground truth map (“Ground-truth Saliency Map” in FIG. 7) to generate a correlation coefficient negative value (e.g., CC_n). Then, a final score(fs) for a specific visual saliency model can be defined as follows: fs=(CC_p)−(CC_n) as shown in FIG. 7.

For example, the center bias map will achieve a high score on the negative density map ND because the map is drawn from the center bias map. A good prediction is supposed to achieve a low score on the negative density map ND, the prediction should not highlight non-salient regions of an image or scene. A main goal of this design is that blindly highlighting the center region, like the center bias map does, will be significantly penalized by the term CC_n. Of course, this procedure can be combined with other saliency metrics, e.g., AUC-based or KL-divergence, and the Pearson Correlation Coefficient (CC) discussed above is merely one type of example.

According to one or more embodiments of the present disclosure, a plurality of visual saliency models can be evaluated and a method can include selecting a visual saliency model from among the plurality of visual saliency models. Also, the selected visual saliency model having the highest score can be used to direct or focus one or more functions or actions. For example, in order to solve a technological problem, the selected visual saliency model can be used for saliency-guided object detection and avoidance (e.g., in self-driving vehicles or robots), but embodiments are not limited thereto. For example, the selected visual saliency model can be used for image quality assessment, advertising and video and image compression.

Regarding self-driving vehicles or robots, the selected visual saliency model of the present disclosure can be used to determine which areas of an image or scene to look at first in order to detect an object or for obstacle avoidance (e.g., identify and avoid a pedestrian) while spending less time and computation on remaining area. This would increase the processing speed, reduce latency in decision making, improve accuracy, and conserve resources and power.

According to one or more embodiments of the present disclosure, saliency information also has applications in video compression, which can detect where an image or scene can be compressed more and vice versa. Thus, it is desirable to be able to better evaluate saliency systems using a more comprehensive measure. Saliency prediction can also be used for volume rendering, which can be applied in the metaverse project. In this situation, salient objects in the scene or view can be rendered with more details, whereas the non-salient objects can be rendered more roughly or with lower resolution, which can speed up the rendering process.

For example, regarding video and image compression, the selected visual saliency model of the present disclosure can be used to determine which areas of an image or scene are more salient or more important, and these portion can be generated with more detail while remaining portions can be generated with less detail. Similarly, the more salient or more important portions of the image or scene identified by the selected visual saliency model of the present disclosure can be applied with less compression, and more or heavier compression techniques can be applied to remaining portions.

In another example, the selected visual saliency model of the present disclosure can be used to improve object detection rates and the detection of important or salient objects. Finding and filtering salient objects or persons can help intelligent home robots navigate a more complex home environment, interact with individuals and complete their tasks. For instance, saliency prediction of the present disclosure can be used to build a better object detection model. Also, the object detector can be applied in sweeping or cleaning home robots, or assertive robots. Thus, it is desirable to be able to effectively measure a saliency system, because a better saliency model can provide a stronger and more accurate object detector, and thus using the improved saliency system of the present disclosure would be advantageous.

In addition, the according to one or more embodiments of the present disclosure, the AI device can receive updated information via one or more sensors, or from other devices or sources. In response to receiving the updated information, the AI device can determine that conditions have changed and the plurality of visual saliency models can be re-evaluated based on the changed conditions to select a different one of the visual saliency models to be used for controlling one or more functions or actions. For example, the type of visual content viewed by a user on TV may change from viewing an action movie to viewing a more static scene such as a power point presentation or documentary. In this situation, the plurality of visual saliency models can be re-evaluated according to the techniques of the present disclosure based on the changed conditions to select a different one of the visual saliency models to be used control how compression or rendering is implemented, in order to better suit the needs of the changing situation. For example, a war movie or a sports event may need to focus more on the center area, while a video conference or a streaming presentation may include a lot of static portions, such as chart and graphs that may need to be treated differently.

In addition, other evaluation methods fail when many fixations are closely distributed near the center. Shuffled-AUC will over-penalize the true fixations (e.g., center region), and Centre-Sub may receive a few peripheral fixations for evaluation, which cannot comprehensively measure saliency. FN-AUC will reduce to Shuffled-AUC by also penalizing the center region. Also, spROC only receives fixation points within the inner regions or bins for evaluation, which cannot show spatial biases.

In contrast to these other techniques, the methods according to an embodiment of the present disclosure regarding the Center-Negative solution are twofold. First, the Center-Negative method proposes to directly draw negative points from the center bias map instead of fixations from other images within a data set. The resulting negative map will significantly overlap with the center bias map regardless of how the ground-truth fixation is distributed. Second, the Center-Negative method is a metric-agnostic solution. Any saliency metrics can be applied on the negative map created by the method according to embodiments of the present disclosure, e.g., Kullback-Leibler divergence, normalized saliency scanpath, and similarity

Various aspects of the embodiments described herein can be implemented in a computer-readable medium using, for example, software, hardware, or some combination thereof. For example, the embodiments described herein can be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, other electronic units designed to perform the functions described herein, or a selective combination thereof. In some cases, such embodiments are implemented by the controller. That is, the controller is a hardware-embedded processor executing the appropriate algorithms (e.g., flowcharts) for performing the described functions and thus has sufficient structure. Also, the embodiments such as procedures and functions can be implemented together with separate software modules each of which performs at least one of functions and operations. The software codes can be implemented with a software application written in any suitable programming language. Also, the software codes can be stored in the memory and executed by the controller, thus making the controller a type of special purpose controller specifically configured to carry out the described functions and algorithms. Thus, the components shown in the drawings have sufficient structure to implement the appropriate algorithms for performing the described functions.

Furthermore, although some aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, Perl, PHP, HTML, or other programming languages. One or more of such software sections or modules can be integrated into a computer system, computer-readable media, or existing communications software.

Although the present disclosure has been described in detail with reference to the representative embodiments, it will be apparent that a person having ordinary skill in the art can carry out various deformations and modifications for the embodiments described as above within the scope without departing from the present disclosure. Therefore, the scope of the present disclosure should not be limited to the aforementioned embodiments, and should be determined by all deformations or modifications derived from the following claims and the equivalent thereof.

What is claimed is:

1. A method for controlling a device to manage a visual saliency model, the method comprising:
receiving, via a processor in the device, a center bias map and a saliency density ground-truth map for an image;
normalizing, via the processor, values of the saliency density ground-truth map to be in a range of 0 to 1 to generate a normalized density ground-truth map;
comparing, via the processor, values of the normalized density ground-truth map to a predefined threshold value to generate an enhanced ground-truth map;
subtracting, via the processor, the enhanced ground-truth map from the center bias map to generate a negative candidates map;
normalizing, via the processor, values of the negative candidates map to be in a range of 0 to 1 to generate a normalized candidates map;
performing, via the processor, a sampling process on the normalized candidates map to generate a negative point map; and
applying, via the processor, a filter function to the negative point map to generate a negative density map.

2. The method of claim 1, wherein the center bias map is a 2D Gaussian distribution.

3. The method of claim 1, wherein the enhanced ground-truth map is a binary map having some values set to 0 and remaining values set to 1 based on the predefined threshold value.

4. The method of claim 1, wherein generating the enhanced ground-truth map includes:
converting some values of the saliency density ground-truth map that are less than the predefined threshold to zero and converting other values of the saliency density ground-truth map that are greater than the predefined threshold to one.

5. The method of claim 1, wherein the negative point map indicates an inclusion probability.

6. The method of claim 1, wherein the sampling process includes Poisson sampling to generate a set of negative points included in the negative point map.

7. The method of claim 1, wherein the filter function is gaussian filter configured to blur portions of the negative point map.

8. The method of claim 1, wherein the saliency density ground-truth map is a type of heat map indicating actual measurements of where viewers eyes have fixated on the image.

9. The method of claim 1, further comprising
receiving, via the processor, a first visual saliency prediction map corresponding to a first visual saliency prediction model; and
comparing the first visual saliency prediction map to the negative density map to generate a first correlation value.

10. The method of claim 9, further comprising:
comparing the visual saliency prediction map to the saliency density ground-truth map to generate a second correlation value; and
generating an evaluation metric for the first visual saliency prediction model based on the first correlation value and the second correlation value.

11. The method of claim 10, wherein the generating the evaluation metric for the visual saliency prediction model includes:
subtracting first correlation value from the second correlation value to generate a score for the first visual saliency prediction model.

12. The method of claim 10, further comprising:
comparing evaluation metrics of a plurality of visual saliency prediction models with each other;
selecting one of the plurality of visual saliency prediction models based on a condition; and
executing a function or action based on a visual saliency prediction map output by the one of the plurality of visual saliency prediction models.

13. The method of claim 12, wherein the function or action includes at least one of a data compression function, an object detection function, and visual graphics rendering function.

14. The method of claim 9, wherein the visual saliency prediction map is a type of heat map indicating predication fixations on the image.

15. A method for controlling a device to manage a visual saliency model, the method comprising:
receiving, via a processor in the device, a center bias map and a saliency density ground-truth map for an image;
generating, via the processor, a negative candidates map based on a difference between the center bias map and the saliency density ground-truth map;
generating, via the processor, a negative density map based on the difference between the center bias map and the saliency density ground-truth map.

16. The method of claim 15, further comprising:
selecting one of a plurality of visual saliency prediction models based metrics indicating relationships between the negative density map and visual saliency prediction maps corresponding to the plurality of visual saliency prediction models; and
executing a function based on a visual saliency prediction map output by the one of the plurality of visual saliency prediction models.

17. The method of claim 15, further comprising:
normalizing, via the processor, values of the saliency density ground-truth map to be in a range of 0 to 1 to generate a normalized density ground-truth map;
comparing, via the processor, values of the normalized density ground-truth map to a predefined threshold value to generate an enhanced ground-truth map;
normalizing, via the processor, values of the negative candidates map to be in a range of 0 to 1 to generate a normalized candidates map;
performing, via the processor, a sampling process on the normalized candidates map to generate a negative point map,
wherein the negative candidates map is generated based on enhanced ground-truth map, and
wherein negative density map is generated based on the negative point map.

18. A device for managing visual saliency models, the device comprising:
a memory configured to store one or more saliency density ground-truth maps for one or more images, the one or more saliency density ground-truth maps corresponding to one or more visual saliency prediction models; and
a controller configured to:
receive a center bias map and a saliency density ground-truth map for an image,
normalize values of the saliency density ground-truth map to be in a range of 0 to 1 to generate a normalized density ground-truth map,
compare values of the normalized density ground-truth map to a predefined threshold value to generate an enhanced ground-truth map;
subtract the enhanced ground-truth map from the center bias map to generate a negative candidates map,
normalize values of the negative candidates map to be in a range of 0 to 1 to generate a normalized candidates map,
perform a sampling process on the normalized candidates map to generate a negative point map, and
apply a filter function to the negative point map to generate a negative density map.

19. The device of claim 18, wherein the controller is further configured to:
receive a first visual saliency prediction map corresponding to a first visual saliency prediction model,
compare the first visual saliency prediction map to the negative density map to generate a first correlation value,
compare the visual saliency prediction map to the saliency density ground-truth map to generate a second correlation value, and
generate an evaluation metric for the first visual saliency prediction model based on the first correlation value and the second correlation value.

20. The device of claim 18, wherein the controller is further configured to:
compare evaluation metrics of a plurality of visual saliency prediction models with each other,
select one of the plurality of visual saliency prediction models based on a condition, and
execute a function based on a visual saliency prediction map output by the one of the plurality of visual saliency prediction models.
